(19) United States
(12) Patent Application Publication
(10) Pub. No.: US 2006/0105461 A1
(43) Pub. Date: May 18, 2006

(54) Nanopore analysis system

(76) Inventors: May Tom-Moy, San Carlos, CA (US); Reid Alyn Brennen, San Francisco, CA (US); Arthur Schleifer, Portola Valley, CA (US); Hongfeng Yin, Cupertino, CA (US); Tom van de Goor, Foster City, CA (US); James Young, La Honda, CA (US); Richard Pittaro, San Carlos, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/971,966

(22) Filed: Oct. 22, 2004

(51) Int. Cl. G01N 35/00

(52) U.S. Cl. 436/43; 422/63

(57) ABSTRACT

Nanopore analysis systems, methods of preparing nanopore analysis systems, and methods of automating the analysis of samples using nanopore analysis systems, are provided.

### BACKGROUND

Nanopore technology is one method of rapidly detecting nucleic acid molecules. The concept of nanopore sequencing is based on the property of physically sensing the individual nucleotides (or physical changes in the environment of the nucleotides, electric current) within an individual polynucleotide (e.g., DNA and RNA) as it traverses through a nanopore aperture. The use of membrane channels to characterize polynucleotides as the molecules pass through a small ion channel has been studied by Kasianowicz et al. (Proc. Natl. Acad. Sci. USA. 93:13770-3, 1996, incorporated herein by reference) by using an electric field to force single-stranded RNA and DNA molecules through a 2.6 nanometer diameter nanopore aperture (i.e., ion channel) in a lipid bilayer membrane. The diameter of the nanopore aperture in a alpha-hemolysin biological pore permitted only a single strand of a polynucleotide to traverse the nanopore aperture at any given time due to the 1.5 nanometer (nm) constriction in the inner portion of the channel. As the polynucleotide traversed the nanopore aperture, the polynucleotide partially blocked the nanopore aperture, resulting in a transient decrease of ionic current. Since the length of the decrease in current is directly proportional to the length of the polynucleotide, Kasianowicz et al. were able to determine experimentally lengths of polynucleotides by measuring changes in the ionic current. Obstruction of the nanopore aperture by gas bubbles can prevent translocation of polynucleotides through the nanopore aperture. Therefore, there is a need for methods of removing gas bubbles from nanopore technology systems.

### SUMMARY

Briefly described, embodiments of this disclosure include nanopore analysis systems, methods of preparing the nanopore analysis system, and methods of automating the analysis of samples using the nanopore analysis system. One exemplary nanopore analysis system, among others, includes an automated nanopore system. The automated nanopore system includes a nanopore chamber and a nanopore structure disposed within the nanopore chamber having a nanopore aperture; and a vacuum system interfaced with the nanopore chamber. The vacuum system is configured to remove a gas bubble within the nanopore chamber without removing the nanopore structure from the nanopore chamber.

Another exemplary nanopore analysis system, among others, includes an automated nanopore system. The automated nanopore system includes a nanopore chamber and a nanopore structure disposed within the nanopore chamber. The nanopore structure includes a nanopore aperture. The automated nanopore system is configured to introduce a plurality of liquid samples into the nanopore chamber in an automated manner. The automated nanopore system is configured to remove the plurality of liquid samples from the nanopore chamber in an automated manner. Each sample can be introduced and removed from the nanopore chamber without removing the nanopore structure from the nanopore chamber. The liquid sample can be a sample liquid and/or a buffer liquid.

Methods of preparing the nanopore analysis system are also provided. One exemplary method, among others, includes: providing an automated nanopore system including a nanopore chamber having a nanopore structure, wherein the nanopore structure includes a nanopore aperture; disposing a first volume of a liquid in the nanopore chamber, wherein at least one gas bubble is formed in the nanopore chamber, and wherein the gas bubble is substantially blocking the nanopore aperture; evacuating the liquid from the nanopore chamber to remove the gas bubble; and flowing a second volume of a liquid into the nanopore chamber, wherein the nanopore aperture is not substantially blocked by gas bubbles.

Another exemplary method of preparing the nanopore analysis system, among others, includes: providing a nanopore system including a nanopore chamber and a nanopore structure having a nanopore aperture, wherein the nanopore chamber has first side and a second side each disposed on opposite sides of the nanopore structure, wherein the nanopore aperture fluidicly connects the first side with the second side; disposing a liquid into the first side and the second side of the nanopore chamber, wherein at least one gas bubble is formed, and wherein the gas bubble is substantially blocking the nanopore aperture; and evacuating the liquid from the first side of the nanopore chamber, wherein the evacuation causes the liquid from the second side to flow through the nanopore aperture to the first side, and wherein the flow of liquid from the second side to the first side removes the gas bubble blocking the nanopore aperture.

Another exemplary method of automating the analysis of samples using the nanopore analysis system, among others, includes: a nanopore analysis system, comprising: providing a nanopore system including a nanopore chamber and a nanopore structure having a nanopore aperture; disposing a first volume of a buffer liquid in the nanopore chamber, wherein at least one gas bubble is formed in the nanopore chamber, and wherein the gas bubble is substantially blocking the nanopore aperture; evacuating the buffer liquid from the nanopore chamber to remove the gas bubble; flowing a first sample into the nanopore chamber, wherein the first sample includes a first polymer, wherein the nanopore aperture is not substantially blocked by gas bubbles; analyzing the first polymer using the nanopore system; removing the sample from the nanopore chamber; disposing a second volume of the buffer liquid in the nanopore chamber; removing the second volume of the buffer liquid from the nanopore chamber; flowing a second sample into the nanopore chamber, wherein the second sample includes a second polymer, wherein the nanopore aperture is not substantially blocked by gas bubbles; and analyzing the second polymer using the nanopore system. The nanopore structure is not removed from the nanopore chamber to remove the gas bubble during the analysis.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

Reference is now made to the following drawings. Note that the components in the drawings are not necessarily to scale.

FIG. 1 is a schematic of an embodiment of a nanopore analysis system.

FIG. 2 is a flow diagram of a representative method for using the representative nanopore analysis system illustrated in FIG. 1.

FIG. 3 is a flow diagram of another representative method for using the representative nanopore analysis system illustrated in FIG. 1.

FIG. 4 is a flow diagram of another representative method for using the representative nanopore analysis system illustrated in FIG. 1.

FIG. 5 is a more detailed schematic of an embodiment of a nanopore analysis system illustrated in FIG. 1.

### DETAILED DESCRIPTION

As described in greater detail here, nanopore analysis systems and methods of using nanopore analysis systems are provided. By way of example, some embodiments provide for a nanopore analysis system capable of analyzing a plurality of samples in an automated manner. The nanopore analysis system is capable of substantially wetting a nanopore structure without having to remove the nanopore structure (e.g., the structure including the nanopore aperture, which is defined by the nanopore structure) from the nanopore analysis system. The term “wetting” or “wets” is defined as a result where only a liquid (e.g., no gas bubbles) or liquid/solid suspension are present within the nanopore structure thereby permitting unimpeded ionic flow (conduction) through a nanopore aperture and a nanopore channel of the nanopore structure. In an embodiment, the ionic flow is measured as conductance when a voltage is applied across the nanopore structure.

The nanopore aperture and nanopore channel can be quite hydrophobic thereby preventing wetting of the nanopore aperture and the nanopore channel. For example, when a polynucleotide translocates through the nanopore, the ionic flow is then measured as a blockage of the current or conductance. Reduction of the ion flux through the nanopore aperture is influenced, at least in part, by the steric properties of the occupying polymer. Therefore, establishing current or conduction through the nanopore channel by wetting the nanopore channel and aperture is necessary to perform nanopore analysis.

Current procedures for wetting include exposing the nanopore structure to methanol and the nanopore buffer (e.g., 1M KCl in a phosphate buffer at a pH of 8.5), in an alternating manner. Wetting can be achieved by moving the nanopore structure from one liquid to the other liquid. However, wetting or conduction can take from about five minutes to one or more hours using this method. The movement of the nanopore structure between the two liquids is done by physically dipping the nanopore structure into one liquid and then into the other liquid. Removing the nanopore structure between each sample analysis is slow and labor intensive. In addition, physically handling the nanopore structure between each sample analysis can alter the electronic (e.g., ionic current) characteristics of the nanopore structure and/or physically damage the nanopore structure.

Therefore, being able to substantially wet the nanopore structure without removing the nanopore structure limits the potential for altering the physical and/or electronic characteristics of the nanopore structure. As a result, the electronic characteristics of a particular nanopore structure can be fully characterized (e.g., quantitatively and/or qualitatively) so that accurate analysis of samples can be reproducibly performed.

In addition, being able to substantially wet the nanopore structure without removing the nanopore structure enables a plurality of samples to be analyzed in an automated manner. In other words, the nanopore structure can be wetted, a first sample can be analyzed, a buffer solution washes away the residual first sample, and then a second sample is analyzed, all of which is performed without removing the nanopore structure from the automated nanopore system. Current systems analyze one sample and then the nanopore structure is removed from the nanopore analysis system and wetted.

By substantially eliminating the step of having to remove the nanopore structure from the nanopore analysis system, embodiments of the nanopore analysis system are capable of and configured for wetting the nanopore structure without having to remove the nanopore structure from the nanopore analysis system and are capable of analyzing a plurality of samples in an automated manner. In addition, the nanopore structure can be quantitatively and/or qualitatively characterized, which should provide more accurate, precise, and reproducible measurements.

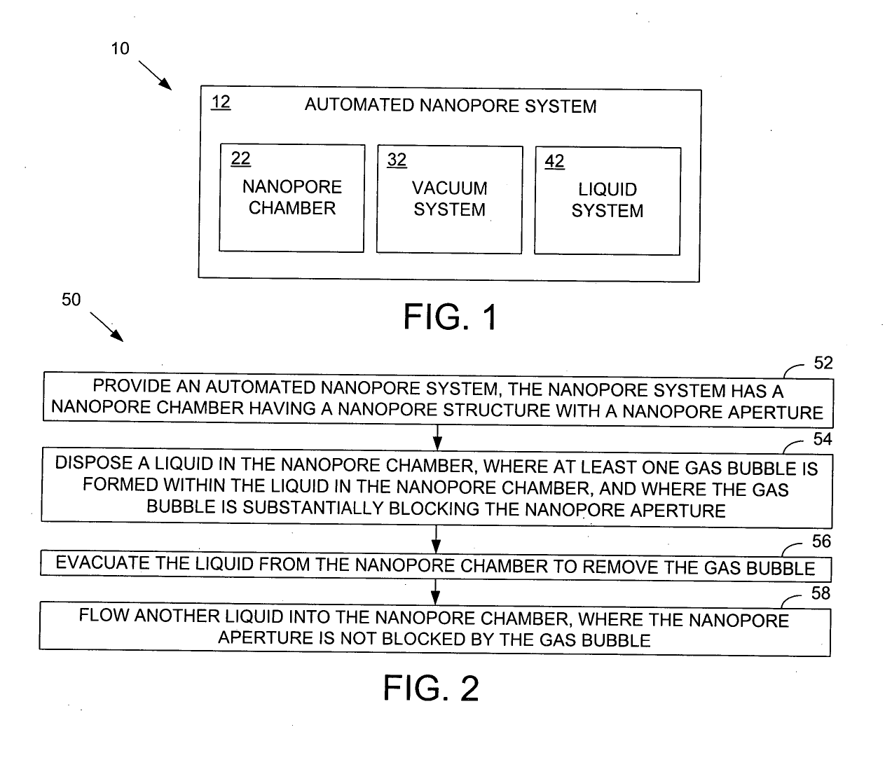

FIG. 1 illustrates a representative embodiment of a nanopore analysis system 10 that can be used to analyze polymers. The nanopore analysis system 10 includes, but is not limited to, an automated nanopore system 12. The automated nanopore system includes, but is not limited to, a nanopore chamber 22, a vacuum system 32, and a liquid system 42. The nanopore chamber 22, the vacuum system 32, and the liquid system 42 are fluidicly coupled so that liquids can be introduced and removed from the nanopore chamber 22.

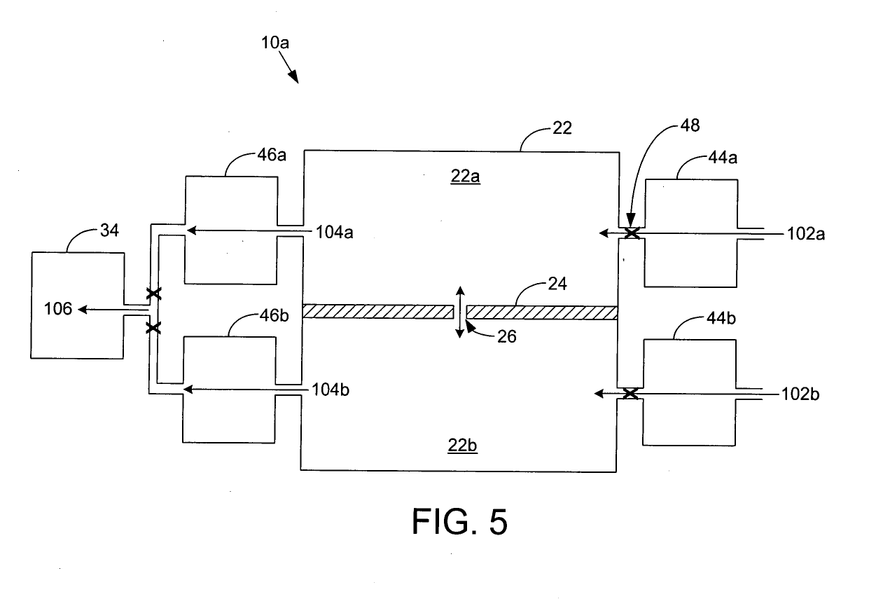

In general, the nanopore chamber 22 includes, but is not limited to, a nanopore structure that divides the nanopore chamber 22 into two sides. The nanopore structure includes a nanopore aperture that fluidicly connects the two sides. An exemplary embodiment of the nanopore chamber 22 is illustrated in FIG. 5, which is discussed in more detail below.

The vacuum system 32 functions to evacuate the nanopore chamber 22 as well as the one or more portions of the liquid system 42. The vacuum system 32 can be interfaced with the liquid system 42 directly and/or indirectly. The vacuum system 32 is in fluidic communication with the nanopore chamber 22 directly and/or indirectly. The vacuum system 32 is configured to apply a vacuum to the nanopore chamber 22 and/or the liquid system 42. Application of the vacuum substantially removes the liquid within the nanopore chamber 22 and/or the liquid system 42. In particular, the vacuum can substantially (e.g., removing the gas bubbles so that the polymer can translocate through the nanopore aperture) remove the gas bubbles formed in the liquid within the nanopore chamber by evacuating the liquid from within the nanopore chamber 22. The vacuum also promotes the evaporation of any liquid that may remain in the nanopore chamber 22 after evacuation. The pressure to which the nanopore chamber 22 and/or the liquid system 42 can be pumped down by the vacuum system 32 depends on the how well each are sealed. The vacuum system 32 can include, but is not limited to, one or more mechanical vacuum pumps, one or more diffusion vacuum pumps, one or more cryogenic vacuum pumps, and combinations thereof.

The liquid system 42 functions to control the flow of liquid samples (e.g., sample liquid (e.g., containing a polymer of interest) and buffer liquid) into and out of the nanopore chamber 22. The liquid system 42 includes, but is not limited to, a nanopore chamber inlet system and a nanopore chamber exit system. The nanopore chamber inlet system and the nanopore chamber exit system can each include, but are not limited to, tubing (e.g., metal tubing, plastic tubing, and combinations thereof), a plurality of flow control valves (e.g., on/off valves, needle valves, multi-port loop valves, and other types of valves), syringes (e.g., to control the flow of liquid and/or introduce one or more liquids to the liquid system 42 and/or the nanopore chamber 22), an air trap and an injection port. The combinations of tubing, valves, and the like, can be designed in various configurations to accomplish the task of controlling the flow of liquid into and out of the nanopore chamber 22, and one skilled in the art could design an appropriate liquid system 42 for a particular application.

In another embodiment, the liquid system 42 may include a microfluidic system that incorporates the same functions as conventional tubing, flow control valves, reaction chambers, filters, mixers, sample separation means, and the like. The vacuum system, excluding the pump itself, may also be formed from a microfluidic manifold that is adapted to manipulate the vacuum much like a microfluidic system manipulates liquids. Further, the nanopore structure may be incorporated into the microfluidic system along with the vacuum system 32 resulting in a single system.

As mentioned above, the vacuum system 32 can be interfaced with the liquid system 42 using various combinations of tubing, valves, and the like. In some embodiments, portions of the liquid system 32 and the vacuum system 42 overlap in that the same tubing, valves, and the like, are used in each system.

The liquid sample can include, but is not limited to, sample liquids and buffer liquids. The sample liquids can include a polymer such as, but not limited to, polynucleotides, polypeptides, and proteins. In addition, the sample liquid can be liquid/solid suspension that includes, but is not limited to, nanoparticles and bionanoparticles.

Use of the phrase “polynucleotide” is intended to encompass DNA and RNA, whether isolated from nature, of viral, bacterial, plant or animal (e.g., mammalian, such as human) origin, synthetic, single-stranded, double-stranded, including naturally or non-naturally occurring nucleotides, or chemically modified.

Use of the phrase “polypeptide” or “protein” is intended to encompass a protein, a glycoprotein, a polypeptide, a peptide, an antigen, an antibody, fragments of each of these, and the like, whether isolated from nature, of viral, bacterial, plant, or animal (e.g., mammalian, such as human) origin, or synthetic, and fragments thereof.

The buffer can include, but is not limited to, phosphate buffers, ionic solutions (e.g., containing KCl, HCl, LiCl, and/or NaCl), surfactants (e.g., Triton X-100, Triton XL-80N, and the like), and combinations thereof.

The nanopore analysis system 10 can also include, but is not limited to, a nanopore detection system (not shown). The nanopore detection system includes, but is not limited to, electronic equipment capable of measuring electronic characteristics of the polymer (e.g., polynucleotides, polypeptides, and the like) as it interacts with the nanopore aperture in the nanopore structure, a computer system capable of controlling the electronic measurement of the characteristics and storing the corresponding data, control equipment capable of controlling the conditions of the nanopore analysis system 10, and other components that are used to perform the electronic measurements.

In general, the nanopore detection system can measure electronic characteristics such as, but not limited to, the amplitude or duration of individual conductance or electron tunneling current changes across the nanopore aperture. Typically, such changes can identify the monomers in the polymer sequence, as each monomer has a characteristic conductance change signature. For instance, the volume, shape, or charges on each monomer can affect conductance in a characteristic way. Therefore, polymers such as polynucleotides can produce distinguishable electronic signatures based on volume and/or shape changes and charge density.

In particular, nanopore analysis of polynucleotides has been described (U.S. Pat. No. 5,795,782 to Church et al.; U.S. Pat. No. 6,015,714 to Baldarelli et al., the teachings of which are both incorporated herein by reference). In general, nanopore analysis involves the use of two separate pools of a medium and an interface between the pools. The interface between the pools is capable of interacting sequentially with the individual monomer residues of a polynucleotide present in one of the pools. Interface-dependent measurements are continued over time, as individual monomer residues of the polynucleotide interact sequentially with the interface, yielding data suitable to infer a structure-dependent characteristic of the polynucleotide. The structure-dependent characterization achieved by nanopore analysis may include identifying physical characteristics such as, but not limited to, the number and composition of monomers that make up each individual polynucleotide, in sequential order.

Nanopore analysis includes, but is not limited to, sequencing to obtain sequence information about the polymer. The term “sequencing” as used herein means determining the sequential order of nucleotides in a polynucleotide molecule. Sequencing as used herein includes determining the nucleotide sequence of a polynucleotide in which the sequence or portions thereof was previously unknown or known.

FIG. 2 is a flow diagram of a representative method 50 for using the nanopore analysis system 10 illustrated in FIG. 1. In block 52, an automated nanopore system is provided. The automated nanopore system includes a nanopore chamber having a nanopore structure, where the nanopore structure includes the nanopore aperture. In certain embodiments, the nanopore structure divides a nanopore chamber into two sides, where the two sides are fluidicly connected via the nanopore aperture such that liquid can flow from one side of the nanopore chamber to the other side of the nanopore chamber.

In block 54, a liquid is disposed into the nanopore chamber, where at least one gas bubble is formed in the fluid within the nanopore chamber. One or more gas bubbles substantially blocks (e.g., prevents the polymer from translocating through the nanopore aperture) the nanopore aperture on one or both sides of the nanopore chamber and/or within the nanopore channel preventing liquid flow (e.g., molecules within the liquid) through the nanopore aperture.

In block 56, the liquid within the nanopore chamber is evacuated to remove both the gas bubbles within the liquid and the liquid. The nanopore chamber can be evacuated using the vacuum system 32.

In block 58, another volume of the liquid can be flowed into the nanopore chamber. Removal of all the gas bubbles from the nanopore chamber promotes the full filling of the nanopore chamber by introducing another volume of the liquid because the gas available to form gas bubbles has been removed. In addition, the volume of fluid is pulled into every part of the nanopore chamber by the vacuum. As a result of removing the gas bubbles, the nanopore aperture is not blocked and liquid can flow through the nanopore aperture.

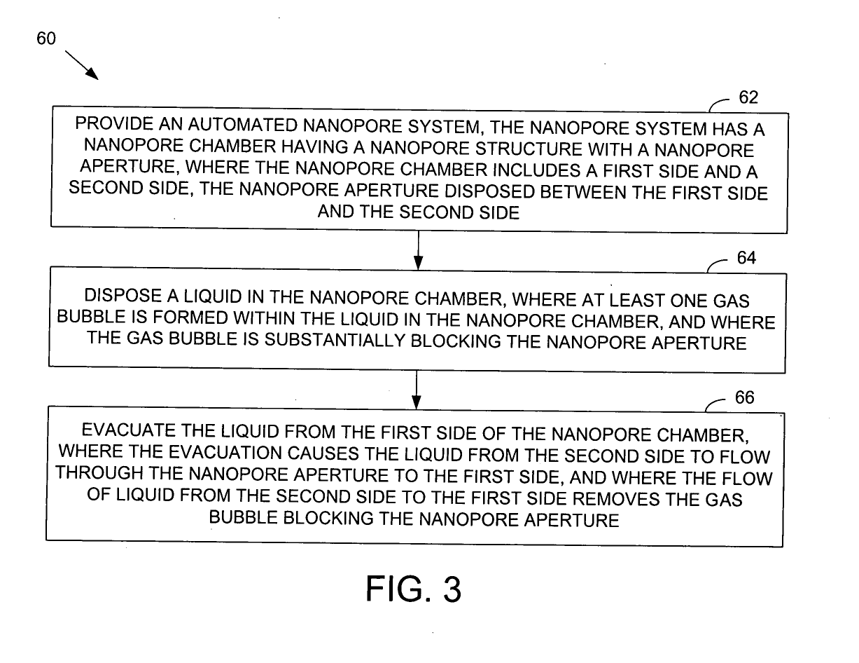

FIG. 3 is a flow diagram of another representative method 60 for using the nanopore analysis system 10 illustrated in FIG. 1. In block 62, an automated nanopore system is provided. The automated nanopore system includes a nanopore chamber having a nanopore structure, and the nanopore structure includes a nanopore aperture. The nanopore structure divides a nanopore chamber into two sides, where the two sides are fluidicly connected via the nanopore aperture.

In block 64, a liquid is disposed into the nanopore chamber, where at least one gas bubble is formed within the liquid in the nanopore chamber and/or the nanopore aperture. One or more gas bubbles substantially block the nanopore aperture on one or both sides of the nanopore chamber and/or within the nanopore channel preventing liquid flow (e.g., molecules within the liquid) through the nanopore aperture.

In block 66, the liquid is evacuated from one side of the nanopore chamber, which causes the liquid to flow through the nanopore aperture. Consequently, the gas bubbles substantially in the way of the nanopore aperture are removed. Therefore, the nanopore aperture is not blocked and liquid can flow through the nanopore aperture.

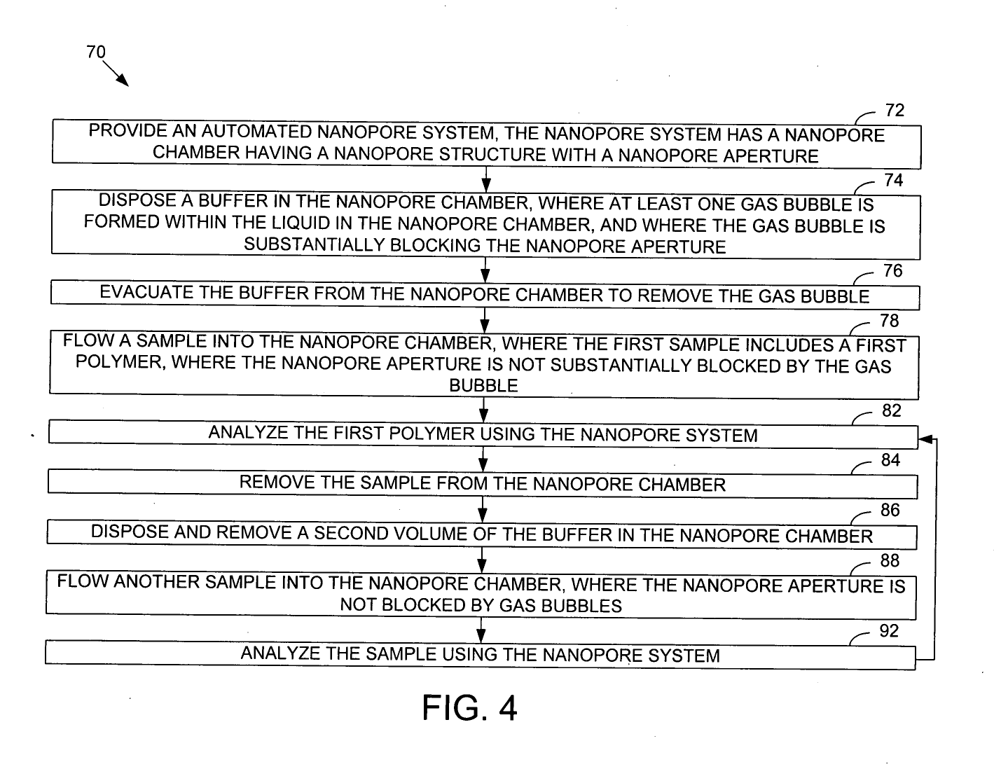

FIG. 4 is a flow diagram of another representative method 70 for using the nanopore analysis system 10 illustrated in FIG. 1. In block 72, an automated nanopore system is provided. The automated nanopore system includes the nanopore chamber having the nanopore structure, where the nanopore structure includes the nanopore aperture. The nanopore structure divides the nanopore chamber into two sides, where the two sides are fluidicly connected via the nanopore aperture.

In block 74, a buffer is disposed into the nanopore chamber, where at least one gas bubble is formed within the buffer in the nanopore chamber. One or more gas bubbles substantially block the nanopore aperture on one or both sides of the nanopore chamber and/or within the nanopore channel preventing liquid flow through the nanopore aperture.

In block 76, the buffer within the nanopore chamber is evacuated to remove the gas bubbles within the buffer, as described in more detail above. The nanopore chamber can be evacuated using the vacuum system 32. In another embodiment, the gas bubble can be removed in a manner consistent with that described in FIG. 3.

In block 78, a sample is be flowed into the nanopore chamber. The sample includes at least a first polymer. As a result of wetting the nanopore structure, gas bubbles are not formed within the sample liquid and therefore, the nanopore aperture is not blocked and liquid can flow through the nanopore aperture.

In block 82, the first polymer is analyzed using the nanopore analysis system. In block 84, the sample is removed from the nanopore chamber. In block 86, a second volume of the buffer is flowed into and out of the nanopore chamber.

In block 88, a second sample is flowed into the nanopore chamber. The sample includes at least a second polymer. In block 92, the second polymer is analyzed using the nanopore analysis system. The process can continue by looping back to block 82 to analyze another sample. A vacuum can be applied to the nanopore structure as needed to remove gas bubbles from one or more liquids.

FIG. 5 is a schematic of a representative embodiment of a nanopore analysis system 10a illustrated in FIG. 1. The nanopore analysis system 10a includes, but is not limited to, the nanopore chamber 22, a vacuum system 34, and a liquid system 44a, 44b, 46a, and 46b. The nanopore chamber 22, the vacuum system 34, and the liquid system 44a, 44b, 46a, and 46b are fluidicly coupled so that liquids can be introduced and removed from a first side 22a and a second side 22b of the nanopore chamber 22.

The nanopore chamber 22 includes, but is not limited to, the first side 22a, the second side 22b, a nanopore structure 24, and a nanopore aperture 26. In general, the nanopore structure 24 can be made of materials such as, but not limited to, silicon nitride, silicon oxide, mica, polyimide, and combinations thereof. The nanopore structure 24 can include, but is not limited to, detection electrodes and detection integrated circuitry. The nanopore structure 24 includes at least one nanopore aperture 26 but could include two or more nanopore apertures. The nanopore aperture 26 is dimensioned so that the polymers can translocate from the first side 22a to the second side 22b, or vice versa, through the nanopore aperture 26. The nanopore aperture 26 can have a diameter of about 1 to 10 nanometers (nm) and in another embodiment from about 3 to 5 nm. The nanopore structure 24 can be from about 1 mm to 12 mm in length, about 0.1 μm to 0.5 μm in height, and 1 mm to 12 mm in width. The first side 22a and the second side 22b can each hold a volume of about 10 μl to 32 μl.

The liquid system includes, but is not limited to, a nanopore chamber inlet system 44a and 44b and a nanopore chamber exit system 46a and 46b. The nanopore chamber inlet system 44a and 44b and the nanopore chamber exit system 46a and 46b can each include, but are not limited to, tubing (e.g., metal tubing, plastic tubing, and combinations thereof) and a plurality of flow control valves 48 (e.g., on/off valves, needle valves, multi-port loop valves, and other types of valves). In addition, the nanopore chamber inlet system 44a and 44b and the nanopore chamber exit system 46a and 46b can each include, but are not limited to, microfluidic channels and interfaces, microfluidic flow capillaries, and other microfluidic flow components and structures.

The first side 22a of the nanopore chamber 22 is in fluidic communication with the nanopore chamber inlet system 44a and the nanopore chamber exit 46a, while the second side 22b is in fluidic communcation with the nanopore chamber inlet system 44b and the nanopore chamber exit 46b.

The vacuum system 34 is in fluidic communication with the nanopore chamber exit system 46a and 46b and is configured to evacuate one or both sides of the nanopore chamber 22 through the nanopore chamber exit system 46a and 46b.

Liquids can be flowed into the first side 22a and the second side 22b through routes 102a and 102b, respectively. The liquid can be flowed out of and/or evacuated out of the first side 22a and/or the second side 22b via routes 104a, 104b, 106, and combinations thereof.

It should be emphasized that many variations and modifications may be made to the above-described embodiments. All such modifications and variations are intended to be included herein within the scope of this disclosure and protected by the following claims.

We claim at least the following:

1. A nanopore analysis system, comprising:
an automated nanopore system including:
a nanopore chamber and a nanopore structure disposed within, the nanopore structure having a nanopore aperture; and
a vacuum system interfaced with the nanopore chamber,
wherein the vacuum system is configured to remove a gas bubble within a liquid disposed in the nanopore chamber without removing the nanopore structure from the nanopore chamber.

2. The nanopore analysis system of claim 1, wherein the nanopore chamber has a first side and a second side and each are disposed on opposite sides of the nanopore structure, wherein the nanopore aperture fluidically connects the first side with the second side; and the nanopore analysis system further comprising:
a first side inlet in fluid communication with the first side and in fluid communication with the vacuum system;
a second side inlet in fluid communication with the second side and in fluid communication with the vacuum system;
a first side exit in fluid communication with the first side and in fluid communication with the vacuum system; and
a second side exit in fluid communication with the second side and in fluid communication with the vacuum system,
wherein the vacuum system is configured to remove the gas bubble within the nanopore chamber through an exit or an inlet selected from the first side inlet, second side inlet, first side exit, second side exit, and combinations thereof.

3. A nanopore analysis system, comprising:
an automated nanopore system including a nanopore chamber and a nanopore structure disposed within the nanopore chamber, wherein the nanopore structure includes a nanopore aperture, wherein the automated nanopore system is configured to introduce a plurality of liquid samples into the nanopore chamber in an automated manner, wherein the automated nanopore system is configured to remove the plurality of liquid samples from the nanopore chamber in an automated manner, wherein the automated nanopore system is configured in a manner whereby each sample can be introduced and removed from the nanopore chamber without removing the nanopore structure from the nanopore chamber, and wherein the liquid sample is selected from a sample liquid and a buffer liquid.

4. The nanopore analysis system of claim 3, wherein the nanopore chamber has a first side and a second side, where each of the sides is disposed on opposite sides of the nanopore structure, wherein the nanopore aperture fluidically connects the first side with the second side; and the nanopore analysis system further comprises:
a first side inlet in fluid communication with the first side and in fluid communication with a liquid source and a vacuum system;
a second side inlet in fluid communication with the second side and in fluid communication with the liquid source and the vacuum system;
a first side exit in fluid communication with the first side and in fluid communication with the vacuum system; and
a second side exit in fluid communication with the second side and in fluid communication with the vacuum system,
wherein the automated nanopore system is configured in a manner whereby the liquid sample can be introduced to the nanopore chamber using the liquid source through an inlet selected from the first side inlet, the second side inlet, and combinations thereof; wherein the automated nanopore system is configured in a manner whereby the liquid sample can be removed from the nanopore chamber using the vacuum system through an exit or an inlet selected from the first side inlet, the second side inlet, first side exit, the second side exit, and combinations thereof.

5. The nanopore analysis system of claim 3, further comprising:
a vacuum system interfaced with the nanopore chamber, wherein the automated nanopore system is configured in a manner whereby a gas bubble within the fluid in the nanopore chamber can be removed without removing the nanopore structure from the nanopore chamber using the vacuum system.

6. A method of preparing a nanopore analysis system, comprising:
providing an automated nanopore system including a nanopore chamber having a nanopore structure, wherein the nanopore structure includes a nanopore aperture;
disposing a first volume of a liquid in the nanopore chamber, wherein at least one gas bubble is formed within the liquid in the nanopore chamber, and wherein the gas bubble is substantially blocking the nanopore aperture;
evacuating the liquid from the nanopore chamber to remove the gas bubble; and
flowing a second volume of a liquid into the nanopore chamber, wherein the nanopore aperture is not substantially blocked by gas bubbles.

7. The method of claim 6, wherein the second volume of liquid is selected from a buffer and a sample.

8. The method of claim 7, further comprising:
applying a voltage gradient across the nanopore chamber to draw a polymer to the nanopore aperture of the nanopore analysis system; and
translocating the polymer through the nanopore aperture.

9. The method of claim 6, wherein evacuating includes:
applying a vacuum to the nanopore chamber.

10. A method of preparing a nanopore analysis system, comprising:
providing a nanopore system including a nanopore chamber and a nanopore structure having a nanopore aperture, wherein the nanopore chamber has first side and a second side, each being disposed on opposite sides of the nanopore structure, wherein the nanopore aperture fluidicly connects the first side with the second side;
disposing a liquid into the first side and the second side of the nanopore chamber, wherein at least one gas bubble is formed within the liquid, and wherein the gas bubble is substantially blocking the nanopore aperture; and
evacuating the liquid from the first side of the nanopore chamber, wherein the evacuation causes the liquid from the second side to flow through the nanopore aperture to the first side, and wherein the flow of liquid from the second side to the first side removes the gas bubble blocking the nanopore aperture.

11. The method of claim 10, further comprising:
flowing a sample into the nanopore chamber, wherein the sample includes a target polymer, and wherein the nanopore aperture is not substantially blocked by gas bubbles;
applying a voltage gradient across the nanopore chamber to draw the polymer to the nanopore aperture of the nanopore analysis system; and
translocating the polymer through the nanopore aperture.

12. The method of claim 10, wherein the liquid is a buffer.

13. The method of claim 10, wherein evacuating includes:
applying a vacuum to the nanopore chamber.

14. A method of automating the analysis of samples using a nanopore analysis system, comprising:
providing a nanopore system including a nanopore chamber and a nanopore structure having a nanopore aperture;
disposing a first volume of a buffer liquid in the nanopore chamber, wherein at least one gas bubble is formed within the buffer fluid in the nanopore chamber, and wherein the gas bubble is substantially blocking the nanopore aperture;
evacuating the buffer liquid from the nanopore chamber to remove the gas bubble;
flowing a first sample into the nanopore chamber, wherein the first sample includes a first polymer, wherein the nanopore aperture is not substantially blocked by gas bubbles;
analyzing the first polymer using the nanopore system;
removing the sample from the nanopore chamber;
disposing a second volume of the buffer liquid in the nanopore chamber;
removing the second volume of the buffer liquid from the nanopore chamber;
flowing a second sample into the nanopore chamber, wherein the second sample includes a second polymer, wherein the nanopore aperture is not substantially blocked by gas bubbles; and
analyzing the second polymer using the nanopore system, wherein the nanopore structure is not removed from the nanopore chamber to remove the gas bubble.
